(19) United States
(12) Patent Application Publication
(10) Pub. No.: US 2007/0088953 A1
(43) Pub. Date: Apr. 19, 2007

(54) Method of preparing a document so that it can be authenticated

(75) Inventors: David Hilton, Glos (GB); Peter Wells, Berkshire (GB); Graham Shaw, Oxon (GB)

Correspondence Address: SYNNESTVEDT LECHNER & WOODBRIDGE LLP, P O BOX 592, 112 NASSAU STREET, PRINCETON, NJ, 08542-0592, US

(73) Assignee: Enseal Systems Limited, Oxfordshire (GB)

(21) Appl. No.: 10/571,187

(22) PCT Filed: Sep. 13, 2004
(86) PCT No.: PCT/GB04/03919

§ 371 Date: Mar. 9, 2006

(30) Foreign Application Priority Data
Sep. 12, 2003 (GB) 0321429.3

(51) Int. Cl. H04L 9/00

(52) U.S. Cl. 713/176

(57) ABSTRACT

This patent concerns a method of enhancing the security of the check cashing operation at locations remote from the issuing bank. A key suitable for cryptographic purposes is encoded onto the check stock in the form of a graphic where the style of the graphic and its means of interpretation are customisable. This permits the decryption of data without the need for online key retrieval. Typical usage occurs when a check is issued and the payee and amount at least are hashed or encrypted using the key decoded from the graphic, the hashed value being added to the check, possibly on the MICR line. At POS or a bank teller the key is decoded from the graphic, the check data is rehashed and compared with the hash value on the MICR line. The key encoded within the graphic may also be a PIN.

### BACKGROUND OF THE INVENTION

1. Field of the Invention

This invention relates to a method of preparing a document so that it can be authenticated. The document may be a check and the method then enhances the security of the check cashing operation at locations remote from the issuing bank.

2. Description of the Prior Art

The advent of Check 21 legislation has given a huge boost to the provision of methods of check authentication based on electronic images. The use of scanners ranging from high speed scanners used at central check processing locations through to desktop scanners has burgeoned. This development provides an incentive to use security methods based primarily on imaging techniques.

In recent years there have been many methods proposed to authenticate checks. One type of authentication already used is the Positive Pay system where a list is made of all issued checks and despatched to the reconciling Banks on a daily basis. This system detects any falsification after the checks have been despatched from the Bank of First Deposit to the issuing Bank.

A more recent version of this system is described in U.S. Pat. No. 6,464,134 (Page, not assigned) where the details of issued checks are sent to a central processing agency to which check cashing outlets have on line access. The central agency confirms that the details on the check correspond to those stored at the time of issue.

A second type of authentication has avoided the necessity of transmitting issue files by adding coded data to the check itself and using methods based on image processing to verify the human readable data.

Abathorn (EPO 699,327B1) select at least two critical items of data and encode them into machine readable form so that verification may be carried out by comparing the machine readable and human readable data. They do not indicate any encryption and it appears that the encoding is in a standard form so that no access will be required to encryption or hashing keys.

ASDC (U.S. Pat. No. 6,233,340) describe a method of authentication in which check variable data is irreversibly encrypted and added to the check in machine readable form such as a bar code. Verification is by regenerating the same machine readable code and comparing the two versions. The keys for encryption have to be known to both encryptor and validator and this fact makes it a less suitable schemes for distributed validation. In a later patent (U.S. Pat. No. 6,549,624) the use of asymmetric (public/private) encryption is proposed thus adding a level of security which would be more appropriate for remote check cashing facilities. In this patent the encrypted data is decrypted to compare it with the human readable data.

ChequeGuard (U.S. Pat. No. 6,073,121) also propose that all of the check data be encrypted and encoded into a machine readable symbol placed above the MICR line. Again verification is by decoding the symbol and comparing with original data. The encryption keys are notified to Banks and businesses in advance.

Payformance (U.S. Pat. No. 6,170,744) describe a similar method of hashing data with the added security of a digital signature, all encoded into a graphical symbol. However, in a pair of more recent patent applications (US20020174334A1, US20020174074A1) the data which is hashed includes a personal identifier to allow for verification of identity at POS. In this case the key for hashing can either be accessed on line at the check cashing outlet or else a verification authority is available online to carry out the process. Also the hashed data is added to the MICR line so that it may be humanly readable or read by a MICR reader, dispensing with the need for scanners and imaging technology.

In all of these methods there is a selection of data which is encoded for verification. The data may be in plain form or encrypted or hashed, and in some cases a digital signature is added for extra security. The handling of the security keys is a prime concern. Where the keys have to be distributed prior to any transaction the method is less appropriate for wide distribution. The problem can be offset to some degree by a public/private key scheme. Another alternative is the use of online access to keys or decryption services.

### SUMMARY OF THE INVENTION

In a first aspect of the invention, there is a method of preparing a document so that it can be authenticated,; comprising the following steps:
(a) selecting data sufficient to authenticate the document;
(b) generating a cryptographic key to encode the selected data;
(c) encoding the cryptographic key so that it forms a digital representation of a graphic image; and
(d) printing the graphic image on the document.

An advantage of an implementation of the present invention, in which the document is a check, is that it provides a higher level of security and is especially appropriate for transactions at check cashing outlets, banks of first deposit or POS. The improvement arises from the inclusion of a graphic on the original check stock which contains the key used to process the check data. Thus according to the invention the authentication will be available without any recourse to on line facilities and hence can be available for remote agencies.

The invention also makes it possible to use a different key for every check thereby increasing the security of the encoding. This key may be used in a variety of ways including some of the previously described techniques for authentication.

This compares with the prior art where the key is either (a) predistributed (b) part of a public/private key scheme (c) available on line or (d) available to a service provider who is on line.

The use of a graphic provides a substantial obstacle to easy fraud both through the technical difficulty of producing a graphical artefact that appears genuine and through the need to have access to the decoding methodology.

There are many situations in which the graphic may be used. One such is where official checks are issued by cashiers. In this case the cashier selects a check from check stock that has a key encoded into a graphic. The key will be randomly generated. The check is first scanned and the interpretative algorithm applied to determine the value of the key. Then a hash is calculated from some combination of variable data on the check, the hash depending on the key encoded in the graphic. This hash is printed onto the MICR line in the allowable positions in the form of a 4 digit number. Alternatively it may be handwritten or printed in any available part of the check.

When such a cashier's check is presented at a POS or other transaction agency, the graphic is again scanned to retrieve the key and the same data as used at issuance is hashed using that key. The number that is obtained is compared with the hash value previously added to the MICR line or elsewhere on the cheque.

In order to enhance security the value of the key derived from the graphic may be fed directly into the hashing algorithm without being revealed to the operator at the time of adding and verifying the hash.

The process of verification can be further automated by retrieving the data on the check by analysing the scanned image and using OCR techniques to interpret the human readable text and the MICR line data.

In an alternative implementation where an individual wishes to write a check on his own account he may use check stock, printed as described with a data bearing graphic, where the graphic also contains a PIN number known only to that individual. When such a check is presented the individual is able to confirm his identity by typing in his PIN to a key pad where its validity will be confirmed by software which will decode the PIN from the graphic by analysing a scanned image of that graphic.

### DETAILED DESCRIPTION

The invention is concerned with the automatic authentication of checks, other documents of intrinsic value, printed packaging or any other object that can carry a printed image. Although the descriptions as given relate to checks only the extension to other documents is trivial. Essentially there is an authentication protocol which depends upon the use of keys whose values are stored in an information bearing graphic.

Below is a description of nature of such graphics and protocols.

Information Bearing Graphics

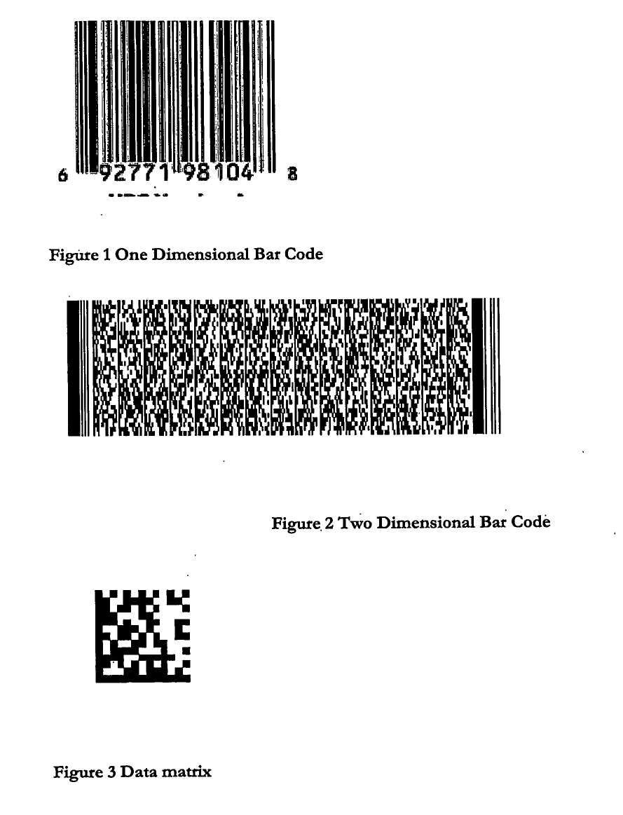

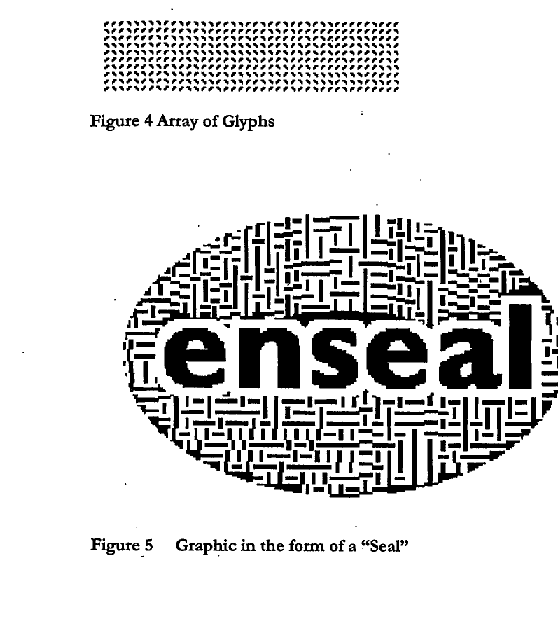

There are many types of information bearing graphics currently in use, most well known being bar codes in one (FIG. 1) or two dimensions (FIG. 2.) There are well established simple designs such as the datamatrix (FIG. 3) and dataglyphs (FIG. 4).

A more flexible approach known as ‘Seal’ encoding is described in patent PCT/GB02/00539 where information bearing graphical symbols may take one of a variety of forms that will fit into the existing design of a document (FIG. 5). ‘Seals’ are two dimensional graphical symbols; when formed into a graphic image, the external shape of the graphic image can be adapted so that it is visually compatible with other images on the document. Also, the appearance of the graphic image can be adapted so that it is visually compatible with other images on the document.

All of these graphics comprise a set of geometric units each of which conveys an amount of information either by virtue of its shape or its dimensions. An important requirement for the use of such graphics is that the printing shall be of sufficient quality and high enough resolution in terms of pixels per inch to allow the coding units to be distinguishable one from another. Thus in a bar code no two bars must be allowed to merge into one another and bars intended to be of different widths must be clearly identifiable as such. Equally when the graphics are scanned the resolution must be sufficient so as to reveal the same distinctions. In practice total reliability can never be assured from the printing and scanning process and so a degree of redundancy is included, usually in a mathematically sophisticated error correction scheme, many examples of which are well described in published texts.

The first stage in the automatic reading of such graphics is the scanning of the document containing them and conversion to an electronic file. A purely geometrical interpretation is the first process to be carried out, reading off the units of information as described above.

The second stage in the interpretation is the conversion of the units to arithmetic form, usually expressed as a string of binary bits or a string of characters of some higher number base. This geometric to arithmetic conversion is often a well established standard, as with bar codes, and will always be known in advance both to the encoder (or printer) and the decoder (or scanner.)

The arithmetic string will at this stage almost certainly contain errors arising from degradation of the document, blobs and missing elements, or from losses due to misalignment of scanners etc. In order to recover the original string an error correction process has to be applied which uses the redundancy in the information to correct any errors or omissions in the data. Following this process the recovered data is in the form of a string whose accuracy is well established.

Frequently as part of the error correction process the geometric units corresponding to any given part of the data may be distributed throughout the graphic in order that localised degradation of a document should not result in loss of sections of information. In the case of Seal encoding this is done explicitly by the use of permutations of data.

The final process is the interpretation of the recovered string. In some case this string corresponds to plain text and may actually consist of ASCII symbols or equivalent. In other cases the string will be an encrypted string probably using a standard encryption such as triple DES or an RSA scheme.

The important point as far as the invention is concerned is that information bearing graphics require several parts in their interpretation, some of which are standard or widely available to decoders, others of which are of controlled access and distributable only to those who are authorised decoders. Further, the parameters which govern the interpretation are usually such that they can be altered at reasonable intervals of time but not necessarily every time an interpretation is to take place, i.e. it is not necessary to be permanently on line.

Authentication Protocols

Authentication protocols produced by Payformance, Sandru et al were referred to in an earlier section. They all have a common framework as described below.

At the time of issuing checks a certain amount of essential information is printed onto the face of the check, whist other information such as the bank's routing number and the account number may be already printed on the check stock. This new information must include at least the amount that is to be paid, but probably includes the date and other information that the paying bank requires such as the payee name. As well as being written on the body of the check the amount is also written in magnetic ink along the bottom of the check in what is known as the MICR line.

Unfortunately fraudsters attempt to subvert the system for their own ends by falsifying the data, typically altering the Payee to their own or an accomplice's name or altering the figure for the amount.

The banks concerned in the check transaction attempt to identify such fraud at the clearing stage when the checks are automatically processed at high speed using powerful scanners. The checks are scanned to electronic files which are processed to extract information. The most relied upon information is extracted from the MICR line which, being written in magnetic ink in a block like font is easily readable. The MICR line contains at least the paying bank's routing number and the amount of the transaction. However, some banks also use Optical Character Recognition (OCR) to read the Payee information.

The authentication protocols attempt to protect this information, which is easily human readable, by encoding the same information in a machine readable form. Apart from the advantage of being machine readable the information is less easily falsified on account of its graphical coding.

There remains a problem that a fraudster may analyse the graphics appearing on checks and determine how they relate to the data unless the graphics are encoded in some way. Thus most of the protocols use one of two methods of encrypting data.

The first method is to ‘hash’ the selected data,.that is to say produce a digest of the data such that it is not possible to discover the original data from the hash. Well known algorithms such as SHA1 and MD5 exist for this purpose. When the check is printed the hash value is added, usually in machine readable form but possibly in human readable form, maybe as four or five digits. At the time of authentication the selected data which has been hashed is read from the check either by an operator or by using OCR. This data is then hashed and the value obtained is compared with the hash value which has been encoded onto the check. If the values agree the check is regarded as authentic.

The second method is to encrypt the data using one of the many well tried encryption schemes that is currently published. This method is essentially the same as the above except that when the encrypted value is read from the check the original selected data should be retrievable using the inverse of the encryption algorithm. The values so obtained can then be compared with the original selected values.

Both of these methods require the provision of an encrypting key and it is the means of the provision of this key that forms the essence of this invention.

There are several proposals already existing for the handling of keys. The most straightforward is to simply distribute the decoding key to all authorised agencies who wish to carry out authentication. The security of issuing a key which is probably in a standard form for carrying out a standard cryptographic process is debatable. A further issue is that large numbers of checks will be issued using the same key and there will probably be many checks with almost identical data. In this circumstance the problem of analysing the encryption method is considerably simplified for any would be fraudster.

An alternative frequently used is to utilise an asymmetric encryption scheme, that is to say a scheme where the decoding keys differs from the encoding key and knowledge of the decoding key gives no information about the encoding method. This solves to a degree the key security problem but does nothing to improve the repetition of data threat.

Probably the maximum security is obtainable if the key is provided on line for every check. This means that at the time of authentication the recipient of the check logs on to a central agency with whom he is registered and requests a decoding key. This may be rather too lengthy a process for a busy check cashing agency.

The method proposed by this invention overcomes the drawbacks of the preceding methods.

Use of Graphically Encoded Keys

In one exemplary implementation of the invention an information bearing graphic is added to check stock as it is printed. This graphic has encoded within it a key, K_{G} suitable for cryptographic purposes. The key is generated preferably by a random process but at least by a non sequential method that makes it difficult to link the key to any data encoded on the stock. The stock is typically printed with a bank routing number and a check and account number as a minimum.

Where such checks are being issued by a bank cashier in the form of an official check the cashier will select an individual check and enter on it the name of the Payee and the amount of the transaction. The cashier will take a selection, S, of the entered data (also the preprinted data e.g. account no.) for the purposes of authentication, either hashing the data producing a value H(S) or encrypting it producing a string E(S) according to whichever protocol the bank has decided upon. In order to carry out this process the cashier will need the appropriate key, K_{G}.

The key, K_{G,} is present on the check in the form of a graphic so the cashier has to interpret the graphic. One method is for the cashier to scan the check and use software that incorporates the graphic encoding algorithm to decipher the key. In a preferred implementation the value of the key is not revealed to the cashier, rather the value is fed straight into the hashing or encryption software without being apparent in any explicit form. An alternative is that a database is generated before the printer prints the check stock, the database indicating which key should be inserted for which check number. This database would also be available to the cashier at the time of issuing the check. The results of the hashing or encryption are entered onto the check either as another graphic or as a character string.

The advantage of this method is that each check has a different key with which to encode the authenticating data and although two checks might be issued successively with similar data the encrypted data in the two cases will differ considerably.

When the check is presented for cashing or for payment for an item the first requirement for authentication is that the key, K_{G,} be read. There is no need to go online to retrieve the key, instead an inexpensive desktop scanner can be used to image the check in electronic form. This can be fed into the software which interprets the graphic and provides the key. The parameters involved in interpreting the graphic, the error correction scheme, any encryption parameters or possible permutations will preferably be downloaded to the check cashing outlet at widely spaced intervals of time. There will be no need to go online for every check, but at the same time the possibility exists to amend the parameters from time to time to enhance security.

If the check has a hash value, H(S) encoded onto it the key, K_{G,} will be used to generate a hash of the appropriate selected data. This generated hash value will be compared with H(S) for the purposes of authentication.

If the check has encrypted data, E(S), encoded onto it then, K_{G}, will be used to decrypt E(S) and the check will be regarded as authentic if the decrypted value is equal to S.

There are many possible variants of the above protocol which all use a similar method of storing the key in graphical form. The data may be any combination of that present on a check or other secure document.

There are also several possibilities for the type of key to be stored depending on the method of hashing or encryption that has been selected. There will be limits to the payload which a graphic can store without its becoming too obtrusive and so the use of methods such as elliptic curve cryptography, where the requirement is for a limited size key only, will simplify matters.

As previously mentioned, one possibility is that the key should in fact be a form of personal identification (PIN). In this case instead of, or as well as, the use of a key to decrypt a string the key could be used in software designed to authenticate the person presenting the check. At the point where the transaction takes place the graphic is scanned to retrieve the key/PIN and the person offering the check independently types in his/her PIN, the application confirming or otherwise the matching of the two values without actually revealing explicitly what that value is.

‘Seal’ encoding allows a particularly convenient method for controlling the decoding of the key on account of its use of permutations to distribute the data. The techniques and software for encoding and decoding remain unaltered through all uses but the permutation can be distributed whenever security and convenience dictate and will alter the details of the graphic making it impossible to for fraudsters simply to identify patterns corresponding to particular data. The permutations can be given in the form of a simple string and the process of introducing a new permutation to the software is of the utmost simplicity.

1. A method of preparing a document so that it can be authenticated; comprising the following steps:
(a) selecting data sufficient to authenticate the document;
(b) generating a cryptographic key to encode the selected data;
(c) encoding the cryptographic key so that it forms a digital representation of a graphic image; and
(d) printing the graphic image on the document.

2. The method of claim 1 comprising the steps of encoding the selected data using the cryptographic key and then printing the encoded, selected data on the document.

3. The method of claim 2 comprising the step of scanning the graphic image to extract the key in order to use the key to encode the selected data.

4. The method of claim 2 comprising the step of looking up the key in a database and then encoding the selected data using that key.

5. The method of claim 2 in which the encoded, selected data can be generated by hashing or encryption using the key.

6. The method of claim 1 in which the selected data comprises data that is printed on the document in a human readable or machine readable form.

7. The method of claim 1 comprising the further step of (a) encoding the selected data by encrypting or hashing the selected data using the key derived or derivable from the graphic image printed onto the document; (b) printing the encrypted or hashed selected data as text or a graphic on the document.

8. The method of claim 2 in which, when the document has to be authenticated, the document is scanned to automatically extract the key by a scanner.

9. The method of claim 8, in which the key extracted by scanning enables authentication because the method comprises the further steps of (a) using the extracted key to encode the selected data printed on the document and (b) automatically comparing the result with the encoded, selected data printed onto the document.

10. The method of preceding claim 9 in which the extracted key is not explicitly revealed at any time but instead fed directly to an algorithm used to encode the selected data printed on the document.

11. The method of claim 8 in which the key automatically extracted by scanning enables authentication because it is a personal identification number and the method comprises the further step of requiring an end-user to enter his personal identification number at a terminal and automatically comparing that number with the number automatically extracted from the scanned graphic.

12. The method of claim 1 in which different keys are automatically generated for different documents.

13. The method of claim 1 in which the key is generated by a random process or other non-sequential method that makes it difficult to link the key to any data encoded on the document.

14. The method of claim 1 in which an algorithm is used to decode the key as part of the authentication process and the method comprises the further step of amending the parameters of the algorithm to enhance security.

15. The method of preceding claim 14 in which parameters needed to decode the key are downloaded to the location at which document authentication is to occur at widely spaced intervals of time and not for each successive document.

16. The method of claim 1 in which the graphic is a one or two dimensional bar-code or other graphical symbol.

17. The method of claim 16 in which the graphic image is a two dimensional graphical symbol and the external shape of the graphic image can be adapted so that it is visually compatible with other images on the document.

18. The method of claim 17 in which the appearance of the graphic image can be adapted so that it is visually compatible with other images on the document.

19. The method of claim 1 in which the document is any object that can carry a printed image.

20. The method of claim 15 in which the document is a check.

21. The method of claim 1 in which a step of authentication occurs at a check cashing outlet, bank of first deposit or point of sale.

22. The method of claim 15 in which the document is printed packaging.

23. A document prepared according to the method of claim 1.
